(19) United States
(12) Patent Application Publication
(10) Pub. No.: US 2004/0044615 A1
(43) Pub. Date: Mar. 4, 2004

(54) Multiple severity and urgency risk events credit scoring system

(76) Inventors: Xun Sean Xue, Tampa, FL (US); Xing-Hong Xue, New York, NY (US)

Correspondence Address: Xun Sean Xue, 2106 S. Grady Avenue, Tampa, FL, 33629, US

(21) Appl. No.: 10/233,799

(22) Filed: Sep. 3, 2002

(51) Int. Cl. G06F 17/60

(52) U.S. Cl. 705/38

(57) ABSTRACT

This invention creates a credit performance valuation system composed of risk cells and risk events. This invention provides a method to classify credit customers into a multitude of different segments according the severity and the urgency of the bad payment behavior specified by risk events. Consequently, this invention measures credit risk by forecasting the likelihood of a customer will be in each segment by analyzing the process of bad credit performance.

Furthermore, this invention designs a conditional modeling process which measures credit risk accurately by predicting the likelihood of a customer reaching different levels of bad performance at different times.

### FIELD OF INVENTION

This invention, “Multiple Urgency and Severity Risk Events Credit Scoring System” is related to the field of consumer lending, in particular, to credit scoring, credit risk management, credit portfolio valuation, and marketing.

### BACKGROUND

The credit industry offers a variety of credit products such as loans and credit cards to consumers. These firms continuously solicit, receive and process applications for these credit products. Approved credits are organized and managed as portfolios. These portfolios may be kept by the originator or may be traded as securities on the secondary market.

By granting consumers credit, creditors face the possibility that customers will miss payments or even default on the credit. The possibility of such problematic credit performance is the credit risk faced by creditors. Consequently creditors measure the risk level of customers to determine if they are creditworthy. If the risk level is underestimated, creditors will suffer losses caused by unexpectedly high level of lost payments and collection costs. Conversely if the risk level is overestimated, creditors will suffer from lost business. Furthermore, investors trade and price securities backed by consumer credit products based on the risk level of customers in the portfolios. As a result, creditors and investors need accurate measurements of credit risk to originate credit products, to manage credit portfolios and to trade on the secondary market.

Creditors use credit scoring systems to measure the credit risk level of customers. The scoring systems measure risk by scoring customer attributes. The result credit score is used by creditors to represent credit risk for originating, managing and trading credit products. Consequently, credit scoring systems significantly affect the bottom line of creditors and are fundamental to the operation of credit products. Any improvement in the accuracy of credit scoring systems would increase profitability and improve the management of credit products.

In prior art, credit scoring systems measured credit risk by scoring the likelihood of “bad” credit performance. Creditors selected the definition of “bad” performance, which was determined while developing a credit scoring system. Typically, “bad” performance was defined using a predetermined performance criterion. The selected criterion was specified by one particular performance status and one specified time period, such as, “60 days past due within two years.” A credit performance was classified as “bad” if the specified performance status occurred within the specified time period. Consequently, the scoring systems classified credit performances as either “bad” or “not bad.” To use a different definition of “bad” performance, a different credit scoring system had to be developed independently using the different “bad” criteria.

However, different “bad” credit performances could cause different levels of loss to creditors. The level of loss caused by a credit performance varied greatly depending on severity and the timing of performance events. A “bad” credit performance that resulted in an account being written-off within the first year would cause significantly higher level of loss than one that caused in an account to become “90 days past due” during the second year. Thus the risk faced by creditors is determined by both the likelihood of bad performance and the severity level of bad performance.

One major shortcoming of the prior arts is that each scoring system can only consider one level of bad performance during one fixed time period. These scoring systems are unable to analyze different levels of bad performance, such as 30 days past due, 60 days past due, 90 days past due, and in foreclosure, and different levels of urgency of bad performances, such as within 6 months, one year and two years. Therefore, each of the prior art scoring system can only forecast the probability of one particular level of bad performance will occur during a fixed period of time in the future but can not forecast the probability of different levels of bad performances will occur during different time periods.

Consequently, the accuracy of these scoring systems is not satisfactory to the creditors. The credit industry has been well aware of the shortcomings and has been working to overcome them. Until now, the efforts have been focused on new definitions of bad performances. As a result, there are a lot of credit scoring systems on the market such as bureau score, bankruptcy score, collections score, mortgage score and etc. . . . Creditors can use more than one of these credit scoring systems to evaluate the credit worthiness of customers. This approach has produced some positive benefits. However, it is still unsatisfactory for two reasons: first, each system still can only deal with one level of bad performance during one time period. Consequently, the above mentioned shortcoming remains as a heritage. Second, all of these scoring systems are developed independently. However, in the real world, the process of bad performance happens dynamically and progressively by severity and by time. Each scoring system in the prior arts only gets a snap shot of this process. When two snap shots are viewed together, creditors can get a better picture of the process, but not the process itself.

Contrary to the prior arts approach, this invention develops a system to assess credit risk by analyzing the process of bad credit performance instead of snap shots. This invention first develops a method to define risk cells. Each risk cell is used to analyze bad performance at one level of severity and one level of urgency. This invention then develops the concept of risk event which deals with several levels of severity and several levels of urgency simultaneously. Furthermore, this invention develops a scoring system to evaluate the credit worthiness of customers based on risk events dynamically. In this way, the scoring system accurately predicts the likelihood of bad performance and the process of bad performance by severity and timing. This improvement is a significant enhancement of prior art credit scoring systems.

### SUMMARY—OBJECT AND ADVANTAGES

This invention “Multiple Urgency and Severity Risk EventS Credit Scoring System”, or RESCS, overcomes the limitations of prior art credit scoring system. This invention assesses credit risk more accurately by measuring both the likelihood and the severity of bad credit performances. Furthermore, this invention measures the severity of bad credit performances according to both the severity and the urgency of performance events.

This present invention classifies customers according to the severity and urgency levels of performance events into a multitude of segments. Since the severity of a credit performance is determined by the severity and urgency of performance events, the credit performances of the customers in each segment have a particular severity level. Consequently, credit risk is measured by forecasting the likelihood a customer will be in each of the segments.

In one embodiment, this invention measures credit risk by using a dynamic scoring system to assess simultaneously the likelihood that a customer will be in multiple cells. This dynamic scoring system allows creditors to assess the roll over risk of customers.

One immediate advantage of this present invention is that it measures credit risk more accurately. The assessment of credit risk is improved by considering the different levels of loss caused by different bad credit performances. With a more accurate measurement of credit risk, creditors can improve the selection of customers for solicitation and approval. Furthermore, creditors can improve the development and implementation of risk-based priced credit products. In particular, the improved assessment of credit risk is especially valuable for the sub-prime lending business.

Accordingly, one advantage of this invention is that it provides a much finer segmentation of customers. Customers are segmented according to the severity and timing of future credit performance events. Customers are divided into segments according to risk levels from the best, “low probability of missing any payments in a long time period,” to the worst,” high probability of default in a short time period.” Furthermore, within each segment, customers are ranked relatively from the best to the worst for further segmentation.

Accordingly, another advantage of this invention is that it improves the management of credit portfolios. Since the customers are finely segmented according to performance, financial institutions can customize its credit management strategy according to the performance characteristics for each segment. As a result, portfolio performance is maximized through better management of servicing and collections.

Accordingly, a further advantage of this invention is that it provides a method to estimate the loss factor for each segment of customers. The loss factor of a segment is the level of loss caused by the customers in the segment. Because this invention divides customers into fine segments by performance events, creditors can accurately measure the loss factor for each segment. As a result, creditors can better predict the size and the timing of losses for portfolios and are able to manage cash flow more effectively.

Accordingly, an additional advantage of this present invention is that credit portfolios can be valued more accurately on the secondary market. By using loss factors for each segment of customers, investors can forecast future income more accurately.

A further advantage of this invention is that creditors can focus on either severity or urgency of performance events for further marginal analysis. Creditors can forecast the urgency of a particular fixed bad performance status or forecast the severity of bad performance during a particular fixed time period.

Yet another advantage of this invention is that creditors are able to forecast additional customer characteristics, such as prepayment, collection effort, customer profitability, fraud, and cross selling potential in addition to performance statuses. Creditors can define risk events to include any customer characteristic of interest. Consequently, creditors are able to incorporate forecasts of these additional characteristics into their decision making process.

Another advantage of this invention is that it is very flexible and highly adaptable. Although this invention allows creditors to develop an industry standard scoring system, similar to the bureau score, this invention also allows each user to define and to use an arbitrary number of risk events for assessing credit risk. Additional options, such as scoring methods, allow users to customize the credit scoring system to fit their needs

Further objects and advantages of this present invention will become apparent from a careful consideration of the ensuing diagrams and descriptions of the invention.

### DESCRIPTION

By the way of introduction, the present invention can be better understood and appreciated by initially considering credit performances in some detail. After receiving credit, the customers are supposed to repay the credit in installments over a period of time according to a payment schedule. Unfortunately, customers often behave differently; some customers may pay a partial amount, may not pay at all or may even declare bankruptcy. When customers deviate from their payment schedule, creditors will incur costs and suffer losses. For example, when customers miss payments or default, creditors will suffer losses from collection expenses and lost payments.

The cumulative payment behavior exhibited by a customer over the life of a credit product is the customer's credit performance. A customer's credit performance status is a characterization of the payment behavior exhibited by the customer at a particular time. For example, credit performance status may be the account status, such as “30 days past due.” In another example, the performance status is the cumulative number of payments missed up to a particular time.

Creditors expect customers to repay each installment in full and on time. Deviations from the expected performance such a missing or late payment may result in losses to creditors. Consequently, the present invention considers any credit performance that deviates from the payment schedule as a bad credit performance. Similarly, a bad performance status is any performance status that characterizes a deviation from the payment schedule.

As mentioned previously, different bad credit performances can cause different levels of loss to a creditor. The level of loss suffered by creditors is determined by customer behavior, specifically the severity and the timing of the deviations from the expected performance. Deviations from the expected credit performance are called performance events. For example, a performance event is missing two consecutive payments.

The severity of performance events measures the magnitude of the deviations from the expected performance. For example, the severity of missing six consecutive payments is greater the severity of missing two consecutive payments. The urgency of performance events measures the timing of the performance deviations. The urgency level of performance events greatly affects the severity of credit performance. If customers default shortly after origination, creditors may lose the entire credit and all future interest income. However, if customers default after three years, creditors may only lose a portion of the credit and lose a portion of the interest income. Since the earlier performance events occur, the greater the severity of credit performance will be, the timing of performance events is referred as the urgency of the performance event. Consequently, the level of loss or the severity level of a bad credit performance is determined by both the severity and the timing of performance events.

This definition of bad credit performance is significantly broader than the “bad” definition from the prior arts. “Bad” credit performance is the collection of credit performances that become seriously delinquent during the life of the credit product. This invention uses this broader definition of bad credit performance so it can distinguish between the different levels of bad performances.

### TERMINOLOGY

By the way of further introduction, some of the terminology and concepts of this invention are introduced and summarized. These terminology and concepts are described in further detail in the introduction and later sections.

| | |
|---|---|
| Credit | The cumulative payment behavior exhibited by a |
| Performance | customer through the life of a credit product is the |
| | customer's credit performance. |
| Performance | Different payment behaviors can cause differently |
| Severity | levels of loss to creditors. The severity of a credit |
| | performance is the magnitude of the loss suffered by |
| | the creditor as a result of the particular payment |
| | behavior. The severity of a credit performance is |
| | determined by the severity and the urgency of |
| | performance events. |
| Performance Events | Customers are expected to perform in a certain way |
| | by creditors. Deviations from the expected credit |
| | performance are called performance event. For |
| | example a common performance event is “missing |
| | two payments”. |
| Performance Event | The severity of a performance event is the |
| Severity | magnitude of the deviation from the expected |
| | payment behavior. For example “missing six |
| | consecutive payments” is more severe |
| | than “missing only one payment”. |
| Performance Event | The urgency of a performance event is the timing of |
| Urgency | its occurrence which can greatly affect the severity |
| | of credit performance. The earlier a performance |
| | event occurs, the greater the impact it has on the |
| | severity level. |
| First Occurrence | First occurrence time is a measure of performance |
| Time | event urgency. The first occurrence time of a |
| | performance event is the length of time from |
| | origination until its occurrence. |
| Performance Status | A performance status is a characterization of the |
| | credit performance exhibited up to particular time. |
| | Generally performance statuses characterize the |
| | severity of the exhibited payment behavior. |
| Risk Cell | A risk cell is a class of customer whose credit |
| | performance exhibit performance events with a |
| | particular level of severity and urgency. For |
| | example, a risk cell may be the set of customers that |
| | defaulted within two years. |
| Risk Event | A risk event may be a risk cell or a combination of |
| | multiple risk cells. This invention assesses credit |
| | risk by forecasting the likelihood of customer will |
| | be in each risk event. |
| Ordered Risk Event | An ordered risk event is a risk event where the |
| | customers are divided into risk cells by the severity |
| | and urgency of their credit performance. The risk |
| | cells are ordered according to the risk order. |
| Risk Order | The risk order of an ordered risk event is the order |
| | of the risk cells. The customers in the first risk |
| | cell have the least severe and least urgent |
| | performance and are the least risky. The customers |
| | in the last risk cell have the most severe and most |
| | urgent credit performance and are the most risky. |

### BRIEF DESCRIPTION OF THE DRAWINGS

In the drawings:

FIG. 1 is a block diagram illustrating the process and the methods of this present invention.

FIG. 2 is a block diagram describing a process to create the risk events classification system.

FIG. 3 is a diagram of two Venn diagrams illustrating risk events.

FIG. 4 is a block diagram describing several processes to create score cards.

FIG. 5 is a block diagram describing the process and the system of the conditional scoring embodiment of this invention.

FIG. 6 is Venn diagram illustrating an ordered risk event.

FIG. 7 is a block diagram describing a process to create conditional performance models using ordered risk events.

FIG. 8 is a diagram illustrating a process to forecast credit performance using conditional credit performance models.

FIG. 9 is a block diagram describing several processes to create credit score cards using conditional credit performance models.

FIG. 10 is a block diagram describing a process to score dynamically using conditional credit performance models.

FIG. 11 is a flow chart illustrating a process to dynamically score credit risk using conditional credit performance models.

### DETAILED DESCRIPTION OF THE PREFERRED EMBODIMENTS

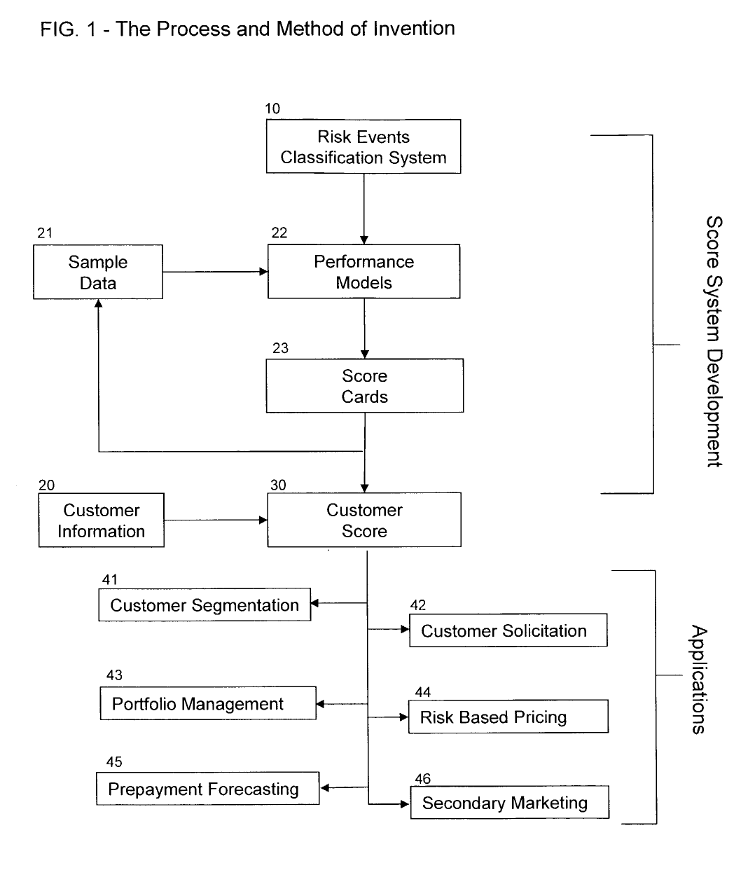

An overview of the system and the operations of this present invention are described with references to FIG. 1. In order to select new customers and to manage existing customers for credit products such as credit cards and mortgages, creditors evaluate customers to measure credit risk. Creditors assess credit risk of customers by considering the performance history of previous customers with similar attributes. Consequently, previous customers are studied to determine how customer information can indicate future credit performance.

Creditors analyze the indicative power of customer attributes by using a selected sample of previous customers, represented by block 21. Typically, the sample includes a large number of customers with known good performance and a large number of customers with known bad performance. The sample may also include a large number of customers who were denied credit. Rejected customers may be added to make the sample more representative of the general population because the sample would only contain customers that are creditworthy. The rejected applicants included in the sample are given fictional accounts and fictional credit performances similar to their expected or inferred performances.

Creditors may only select customers with specific characteristics to create a homogeneous sample to improve accuracy. By using a homogeneous sample, creditors can limit the effect of environmental factors such as the state of the economy and focusing on customer-specific attributes. For example, a sample that is homogeneous in age may only include customers that applied for credit during a short time period. By using a sample that is homogenous in age, creditors can greatly reduce the effect of factors that varies with time.

Creditors evaluate the customers in sample 21 to identify bits of information, or characteristics that may indicate future performance and credit risk level. Some of the common characteristics considered by risk are number of credit lines, utilization of credit lines, income level and debt to income ratio. Customer attributes are the specific characteristics of a particular customer.

Sample 21 is analyzed to study the ability of customer attributes to indicate future credit performance. Creditors analyze the correlation between customer attributes and some particular performance outcomes. For example, creditors may study the correlation between customer attributes and accounts that are in bankruptcy. Typically, creditors evaluate the indicative power of customer attributes by developing credit performance model 22 that forecasts future outcome.

Generally credit performance is modeled using statistical models, in particular, the logistic regression model. In a logistic regression performance model, the independent variables are customer attributes and the dependent variable is the dummy variable, whether a particular performance outcome will occur. The coefficients of the attributes are calculated from the sample to measure the correlation between the attributes and the occurrence of the specified future outcome. Thus, performance model 22 uses the customer attributes to forecast the likelihood of a specific future performance outcome.

The coefficients of customer attributes from performance models are used to develop credit score cards 23. The credit score card is essential a list of possible customer attributes with their corresponding point value. Customer attributes are given different point values according to their correlation with future performance. Customer attributes that are better indicators of future performance are given correspondingly more weight. The performance model coefficients are used to determine the point values. The point values are often be scaled for convenience, for example, so that the possible score will have a particular score range.

Customers are scored by using the score cards from block 23. Credit score cards are used by credit officers to easily assess the credit risk based. Credit officers gather information 20 from credit applications, credit bureaus and other sources to determine a customer's attributes. For each customer attribute that also appears on the score card, the customer receives the corresponding point value. The total of points received from the score card is the customer's credit score from the card.

Traditionally, score cards are printed hard copies that list the point values for each customer attributes. Computers are used to automate the scoring process. Computerized scoring systems are convenient for creditors since customer information is recorded in computers.

The resultant score 30 is used by creditors for credit approval 41, customer solicitation 42 and portfolio management 43. Some further applications of the credit score are represented by blocks 44, 45, and 46. These applications are discussed in further detail in a later section.

The system and the operations of this invention are better appreciated by considering the prior art. As already noted, in the prior art, customers are classified either as “bad” or “not bad” according to a predetermined criterion. A performance model is developed to forecast the likelihood of future credit performance will be “bad.” The performance model is used to develop a score card. The credit score from the score card measures the likelihood of “bad” performance of occurring.

This invention departs from the prior arts by classifying customers into a multitude of segments according to their payment behavior. Credit risk is measured by forecasting the likely future performance as a process. In particular, creditors classify the customers into segments such that the credit performance of the customers in each segment exhibit performance events of specific severity and urgency level. These segments of customers are called risk events since the customers are segmented by performance events. Since the severity level of a credit performance is determined by the timing and the urgency of the performance events, the customers in a risk event exhibit credit performances with multiple severity and urgency levels. Creditors select the performance characteristics used to segment the customers into risk events. The resultant classification is the risk events classification system and is represented as block 10.

This classification system is used to assess credit risk more accurately by measuring the likelihood of each level of credit performance represented by the risk events. Credit performance models are developed for each of the risk events in classification system 10 using sample 21. The performance model for a risk event forecasts the likelihood of a customer will be in the risk event. The performance models are used to develop a score card for each risk event. The score from a score card measures the likelihood of one level of bad performance represented by the risk event. Consequently, the system of multiple score cards measure credit risk accurately by evaluating both the likelihood and the severity of bad credit performance.

This classification system is very flexible and highly adaptable to different situations. The classification system divides customers into multiple risk events representing different severity levels according to the performance characteristics selected by creditors. The selected performance characteristics may result in overlapping risk events, meaning a customer may be classified into more than one risk event. Consequently, this classification system allows to creditors to classify and analyze customers according their particular needs and interests.

This classification system clearly demonstrates the advantage and the advances of this invention. This invention is more flexible, more accurate, and broader than the prior art. Using the concepts of this classification system, prior art credit scoring system is a special case of this invention which classified customers using one risk cell and, therefore, only one severity level. This invention, however, classifies customers into a multitude of risk events. Each of the risk events is scored to measure the risk of each particular level of credit performance. Using this invention, creditors can develop risk events credit scoring system to measure the likelihood of an arbitrary number of future performance outcomes. By measuring the likelihood of different performance outcomes, creditor can better predict future performance process more accurately.

For example, a creditor can create a multiple risk events credit scoring system to assess credit risk by considering and distinguishing the risk different levels of bad credit performance such, as becoming 60 days past due within one year, becoming 90 days past due within two years and defaulting within three years. Furthermore, a creditor can simultaneously assess credit risk for different purposes, such as risk management, collections effort, loss estimation, portfolio valuation, prepayment forecasting, and even bankruptcy forecasting, without comprising the usefulness for any purpose.

Performance Classification

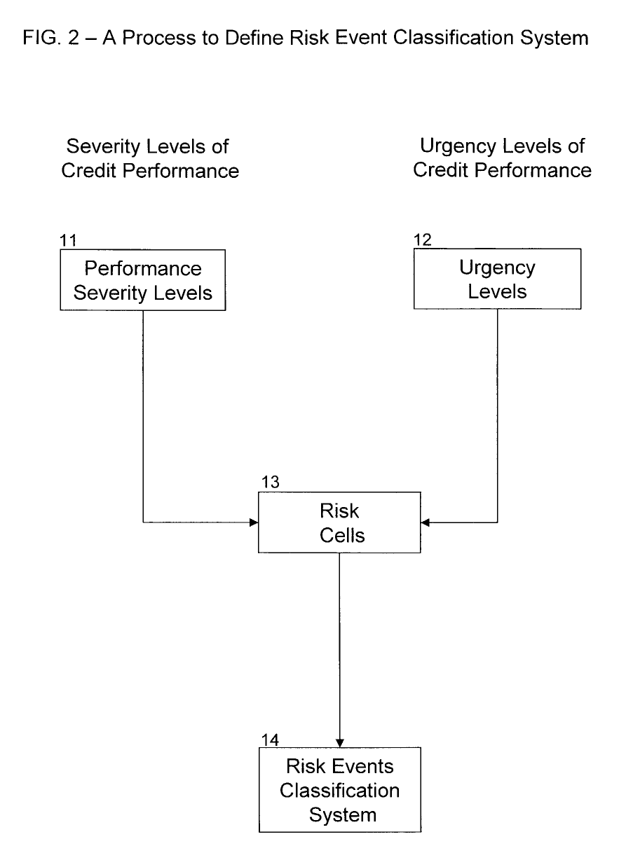

With reference to FIG. 2, the risk event classification system is described in further detail. As described above, the risk event classification system classifies customers according to their payment behavior, specifically the severity and the urgency level of the performance events.

Severity of Performance Events

Performance events are classified by using a set of performance statuses, represented by block 11. The set of performance statuses is selected by the creditor to classify different possible performances events by severity.

Performance statuses are ordered according to severity. Performance status A is more severe than performance status B if status A can occur only after status B has already occurred. This order is denoted by “A>B” or “B<A”. If two statuses can not occur before each other, their relationship is said to be indeterminate.

In one embodiment, account statuses are selected to characterize performance events. For example, the set of performances statuses selected is denoted as, {A₁, A₂, A₃, A₄, A₅} and is ordered by severity, A₅>A₄>A₃>A₂>A₁ where:

| | |
|---|---|
| A₁ | {All accounts are current} |
| A₂ | {Only one account is 30 days past due} |
| A₃ | {At least one account is 60 days past due} |
| A₄ | {At least one account is 90 days past due} |
| A₅ | {At least one account is charged-off}. |

In another embodiment, performance events are characterized by the cumulative number of missed payments up to a particular time. For example, the set of performance statuses is denoted by {D₀, D₁, D₂, D₃, D₄, D₅, D₆} and is ordered by severity, D₆>D₅>D₄>D₃>D₂>D₁>D₀, where:

| | |
|---|---|
| D₀ | {Have never missed a payment} |
| D₁ | {Have missed one payment but not more than one payment} |
| D₂ | {Have missed two payments but not more than two payments} |
| D₃ | {Have missed three payments but not more than three payments} |
| D₄ | {Have missed four payments but not more than four payments} |
| D₅ | {Have missed five payments but not more than five payments} |
| D₆ | {Have missed at least six payments}. |

In an additional embodiment, the performance statuses include prepayment status and/or bankruptcy status. For example, the set of performance status is denoted as {A₁, A₂, A₃, A₄, B₁, B₂, B₃, B₄}, where: A₁, A₂, A₃, A₄ are defined as before and

| | |
|---|---|
| B₁ | {At least two accounts are 30 days past due} |
| B₂ | {Accounts in bankruptcy} |
| B₃ | {At least one account is prepaid} |
| B₄ | {Back payments are made after one collection call}. |

Some of the performance statuses in this example may be ranked by severity, for example, A₁<A₂<B₁ and A₁<B₄. However, the severity relationship between B₁ and A₃ is indeterminate. Furthermore, neither B₂ nor B₃ can be ranked by severity with any one of A₂, A₃, A₄, and A₅.

These embodiments only describe several sets of performance statuses used to classify performance events by severity. Creditors may choose to use any set of performance statuses to classify performance events.

Urgency of Credit Performance

The timing or the urgency of a performance event is specified using the first occurrence time of this performance status. The first occurrence time of a performance status is the first time it occurs during an observation time period. The first occurrence time is used to specify the urgency level of performance events.

Thus, for the performance status A₃,

A₃={At least one account is 60 days past due};

the first occurrence time of A₃, denoted as TA₃, is defined as:

TA₃=The first time when A₃ occurs during the observation time period.

Equivalently, TA₃ equals to the length of time from the beginning of the observation period to the moment A₃ first occurs. Block 12 in FIG. 2 represents the urgency levels selected by creditors.

For example, if the creditor wants to forecast credit performance for the next five years, then the observation period is five years. For a customer, if the performance status, A₃, first occurs during the 18th month, then TA₃=18 months. For another customer, if the performance status, A₃, first occurs during the 48th month, then TA₃=4 years

Risk Cell

The combination of a performance status from block 11 and an urgency level from block 12 is a performance characteristic that specifies both the urgency and the severity levels of performances events. The collection of customers with this characteristic is called a risk cell since is it defined by two characteristics, like a spreadsheet cell. Risk cells are represented by block 13.

The following examples of risk cells illustrate this definition. The risk cell {TA₃=<2 years} is the collection of all the customers with the performance characteristic of having the status A₃, “At least one account is 60 days past due”, occur within the first two years. Another risk cell {TA₅=<1 year} is the collection of all the customers with the performance characteristic of having the status A₅, “At least one account is charged-off”, occur within first next year. Obviously, a credit performance in the risk cell {TA₅<=1 year} is more severe and more urgent than a credit performance in the risk cell {TA₃=<2 years}. This represents the risk order.

The following table gives additional examples of risk cells:

| Risk Cell | Performance Status and Urgency |
|---|---|
| {TA₂ =< 2 years} | “Only one account is 30 days past due” first |
| | occurs within 2 years. |
| {TA₃ =< 3 years} | “At least one account is 60 days past due” first |
| | occurs within 3 years. |
| {TA₃ =< 18 months} | “At least one account is 60 days past due” first |
| | occurs within 18 months. |
| {TA₅ =< 8 months} | “At least one account is charged-off” first |
| | occurs within 8 months. |
| {TB₂ =< 1 year} | “Accounts in bankruptcy” first occurs within |
| | 1 year. |
| {TB₃ =< 1 year} | “At least one account is prepaid” first occurs |
| | within 1 year. |

Risk Events

This invention assesses credit risk by forecasting the likelihood of a customer to be in each of the risk events in the classification system. The risk events in the classification system 14 are specified using the risk cells from block 13. Each of risk events is a set of risk cells or a combination of multiple risk cells joined using set operations such as “and”, “or” and “not.”

The following table gives examples of risk events.

| Risk Event | Multiple Levels of Severity and Urgency |
|---|---|
| E₁: {TA₂ =<3 years} or | “One account is 30 days past due” first occurs |
| {TA₃ =< 2 years} | within 3 years”; or “At least one account is |
| | 60 days past due” first occurs within 2 years. |
| E₂: {TA₃ =< 3 years} | “At least one account is 60 days past due” first |
| and {TA₄ > 3 years} | occurs within 3 years, and “Any account is |
| | 90 days past due” will not occur within 3 years. |
| E₃: {4 years > TA₃ >= | “At least one account is 60 days past due” first |
| 3 years} or {3 years > | occurs in the third year or “At least one account |
| TA₄ >= 2 years} | is 90 days past due” first occurs in the second |
| | year. |
| E₄: {TA₃ >= 3 years} | “At least one account is 60 days past due” |
| and {TB₃ >= 4 years} | doesn't occurs within 3 years and “At least one |
| | account is prepaid” doesn't occur within |
| | 4 years. |
| E₅: {TA₅ =< 2 years} or | “At least one account is charged-off” first |
| {TB₂ =< 1 years} or | occurs within 2 years; or “Accounts in |
| {TB₃ =< 3 years} | bankruptcy” first occurs within one year; or |
| | “At least one account will be prepaid” first |
| | occurs within three years. |

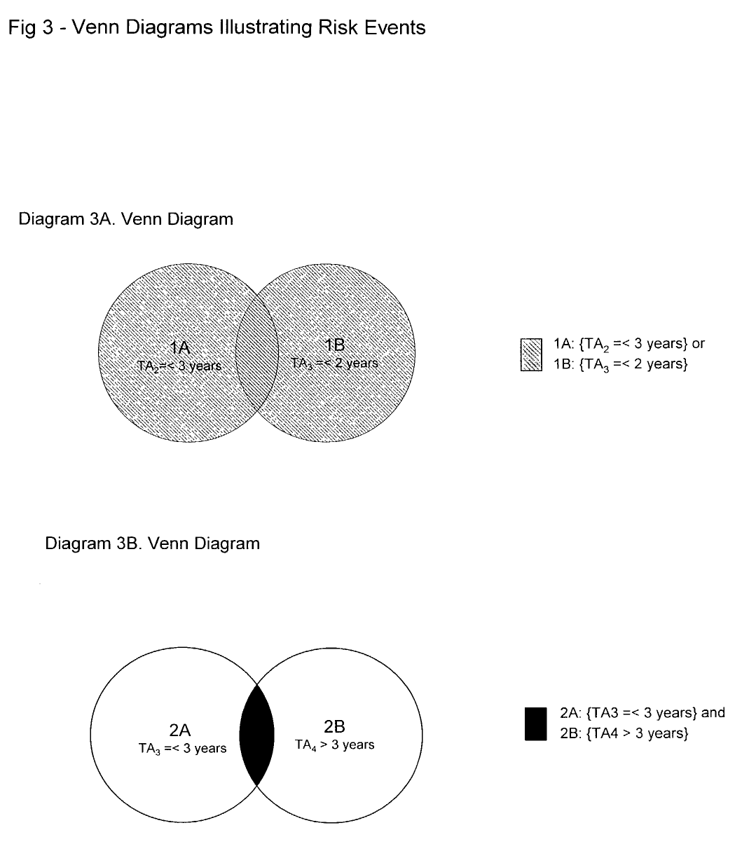

With reference to the Venn diagrams in FIG. 3, risk events in the above table are described in further detail. Diagram 3A illustrates risk event E₁ which is the combination of two risk cells. Circle 1A represents the risk cell {TA₂=<3 years} and Circle 1B represents the risk cell {TA₃=<2 years}. Since the risk cells are combined using the “or” operator, the risk event E₁ is the union of the two risk cells and is represented by the entire shaded area. Thus the risk event E₁ contains all the credit performances in the two risk cells.

Diagram 3B illustrates risk event E₂ which is also the combination of two risk cells. Circle 2A represents the risk cell {TA₃=<3 years} and Circle 2B represents the risk cell {TA₄>3 years}. Since the risk cells are combined using the “and” operator, the risk event E₂ is the intersection of the two risk cells and is represented by the cross-thatched area. Thus the risk event E₂ only contains the customers whose the credit performances that are in both risk cells.

Usually, a risk event contains customers whose credit performances contain performance events of different severity levels and occurs at different times. Consequently, creditors can use risk events to analyze the process of bad credit performances. The risk events selected by creditors form an outline of the process of a bad performance. The severity and the urgency levels specified by a risk event characterize a credit performance at different times. Consequently, by forecasting the likelihood of a customer to be in a risk event, creditors are forecasting the likelihood of the particular payment process outlined by the risk events. As a result, by using risk events, creditors assess credit risk by considering the process of credit performance instead of mere snapshots.

Credit Performance Modeling Using Multiple Risk Events

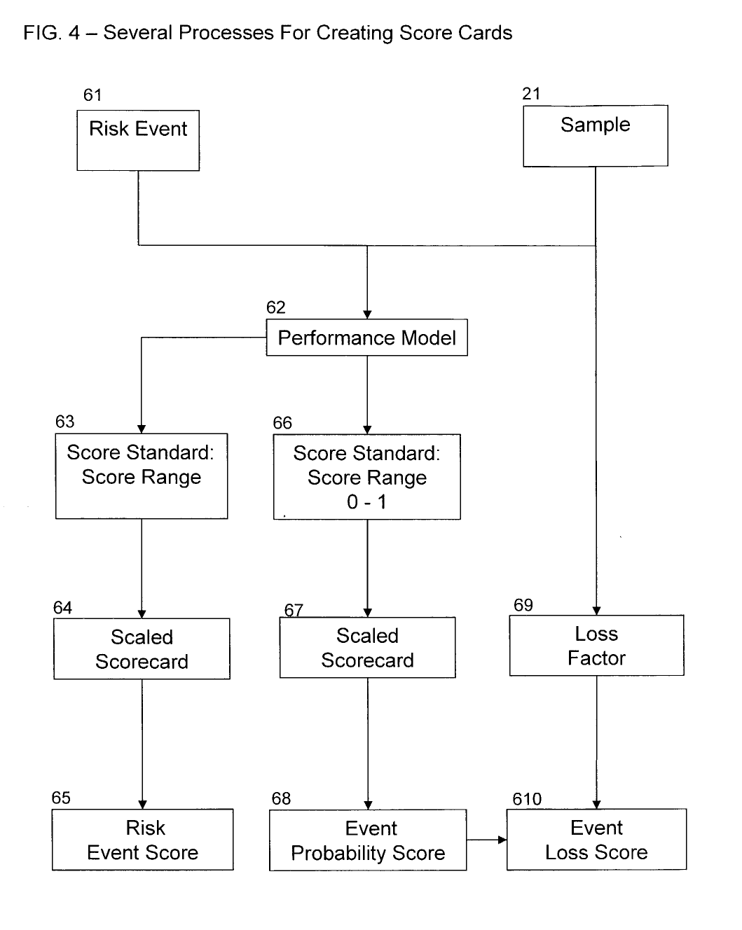

Since credit performances are classified using multiple risk events, this invention uses multiple score cards to score customers. With reference to FIG. 4, a block diagram, the process and the system to develop risk event score cards and to score customers are described in further detail.

The sample 21 is used to develop performance model 62 for risk event 61. This performance model forecast the likelihood of a customer will be in the risk event. The attribute coefficients from performance models 62 are scaled according to score standard 63. Typically, the score standard specifies the score range for the score card selected by the creditor. The scaled coefficients are used to create score card 64 which is used to score customers. The score from score card 64 is the Event Score 65 for risk event 61. The following table is an example of Event Scores for a customer from a system with five risk events respectively.

| Risk Event | Risk Cells | Event Score |
|---|---|---|
| E₁ | {TA₂ =< 3 years} or {TA₃ =< 2 years} | 700 |
| E₂ | {TA₅ =< 2 years} or {TB₂ =< 1 years} | 650 |
| E₃ | {TA₃ =< 3 years} and {TA₄ > 3 years} | 550 |
| E₄ | {TA₃ >= 3 years} and {TA₃ < 4 years} | 700 |
| E₅ | {TA₃ >= 3 years} and {TB₃ >= 4 years} | 600 |

The set of scores from the score cards is the customer's score. Continuing the example, the customer's score would be {700,650,550,700,600}.

Event Probability Score

In another embodiment, the score from the score card is the probability of a customer will be in the risk event. The score standard 66 specifies the score range is from 0 to 1. The model coefficients are scaled according to score standard 66 to create score card 67. The point total from score card 67 is the Event Probability Score 68.

The following table is an example of Event Probability Scores for a customer from a system with five risk events.

| Risk | | Event |
|---|---|---|
| Event | Risk Cell | Probability Score |
| E₁ | {TB₁ =< 3 years} or {TA₃ =< 2 years} | 5.56% |
| E₂ | {TA₅ =< 2 years} or {TB₂ =< 1 years} | 8% |
| E₃ | {TA₃ =< 3 years} and {TA₄ > 3 years} | 15% |
| E₄ | {TA₃ >= 3 years} and {TA₃ < 4 years} | 5.56% |
| E₅ | {TA₃ >= 3 years} and {TB₃ >= 4 years} | 9% |

The set of probability from the score cards is the customer's score. Continuing the example, the customer's score would be {5.56%, 8%, 15%, 5.56%, 9%}.

Event Loss Score

Yet in another embodiment, the score measures the expected loss from a customer in the risk event. The system uses Event Probability Score 68 for a customer. This result is multiplied with the loss factor 69 for the risk event. The loss factor of a risk event is actual loss rate experienced by creditors from past performances in the risk event. The loss factor is calculated using empirical loss data from the sample 21 to find the average annual loss. The result is the Event Loss Score or Annual Loss Factor 610.

The following table is an example of Event Loss Scores/Annual Loss Factors for a customer from a system with five risk events.

| | | Event Loss Score/ |
|---|---|---|
| Risk | | Annual Loss Factor |
| Event | Risk Cell | (% of Credit) |
| E₁ | {TB₁ =< 3 years} or {TA₃ =< 2 years} | 1% |
| E₂ | {TA₅ =< 2 years} or {TB₂ =< 1 years} | 0.8% |
| E₃ | {TA₃ =< 3 years} and {TA₄ > 3 years} | 1.5% |
| E₄ | {TA₃ >= 3 years} and {TA₃ < 4 years} | 1% |
| E₅ | {TA₃ >= 3 years} and {TB₃ >= 4 years} | 1.2% |

The set of ratios from the score cards is the customer's Event Loss Score. Continuing the example, the customer's score would be {1%, 0.8%, 1.5%, 1%, 1.2%}.

Conditional Embodiment

In an embodiment of this invention, a dynamic scoring system is used to score risk events by considering conditional risk or roll-over risk. As previously described, performance statuses are ranked by severity and by the order of occurrence. This ordering system is based on the fact that more severe performance statuses can occur only after less severe performance status. For example, if an account reaches 90 days past due, this account must also have reached 60 days past due. Consequently, this embodiment assesses credit risk by evaluating the likelihood of customer performance will worsen, or the likelihood of customer performance continues to deviate from payment schedule. The risk of a customer's bad payment behavior will continue is the conditional or roll-over risk.

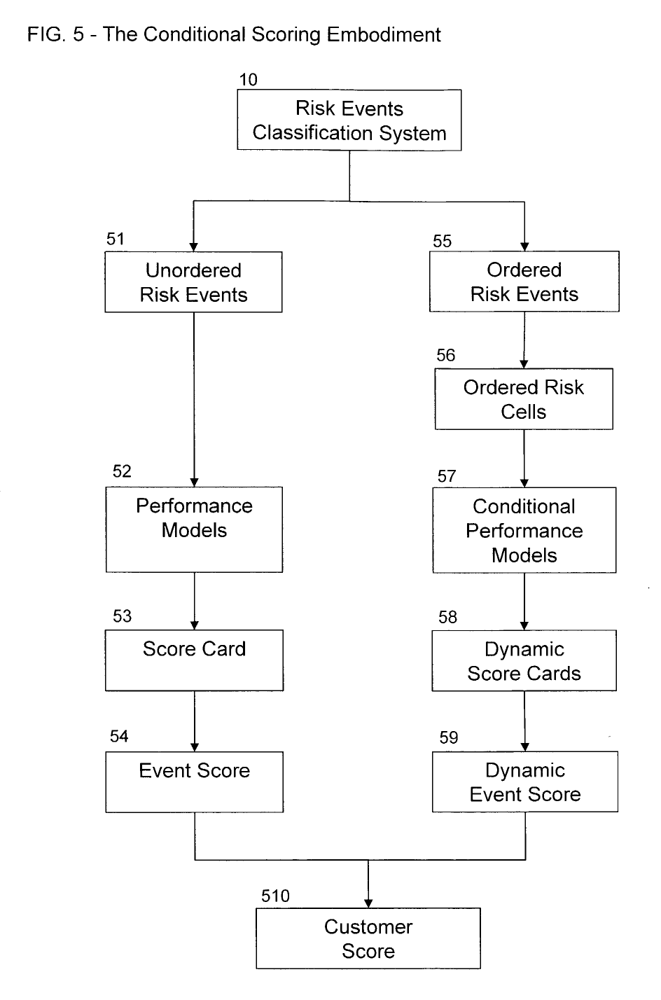

With reference to FIG. 5, this embodiment is described in further detail. In this embodiment, the customers in at least one of the risk events in the classification system 10 are furthered classified according to severity levels. The risk events that are further classified and referred to as ordered risk events and are represented by block 55. The unordered risk events are represented by block 51.

The customers in an ordered risk event are classified into a set of ordered risk cells, represented by block 56, where each of the risk cells is a sub-set of the customers in the risk event. The risk cells in the ordered set are ordered by inclusion, meaning each subsequent risk cell is a contained subset of the customers in the preceding risk cell.

Thus in an ordered risk event, customer are segmented according to both the severity and the urgency of performance statuses. The risk cells are ordered such that a risk cell precedes another less risky risk cell if and only if both the severity and the urgency of the performance characteristic of the first cell are less than that of the second risk cell. If neither risk cells precedes the other, the order is indeterminate. This order is the risk order of the risk event.

In an ordered risk event, none of its risk cells have the same order. Consequently, the customers in an ordered risk event are divided into a series of risk cells in which the first risk cell is the set of customers with performance events of the least severity and the least urgency level. The last risk cell is the set of customers with performance events with the greatest severity and greatest urgency level. Consequently, the risk cells rank the customers by risk from the least risky to the most risky.

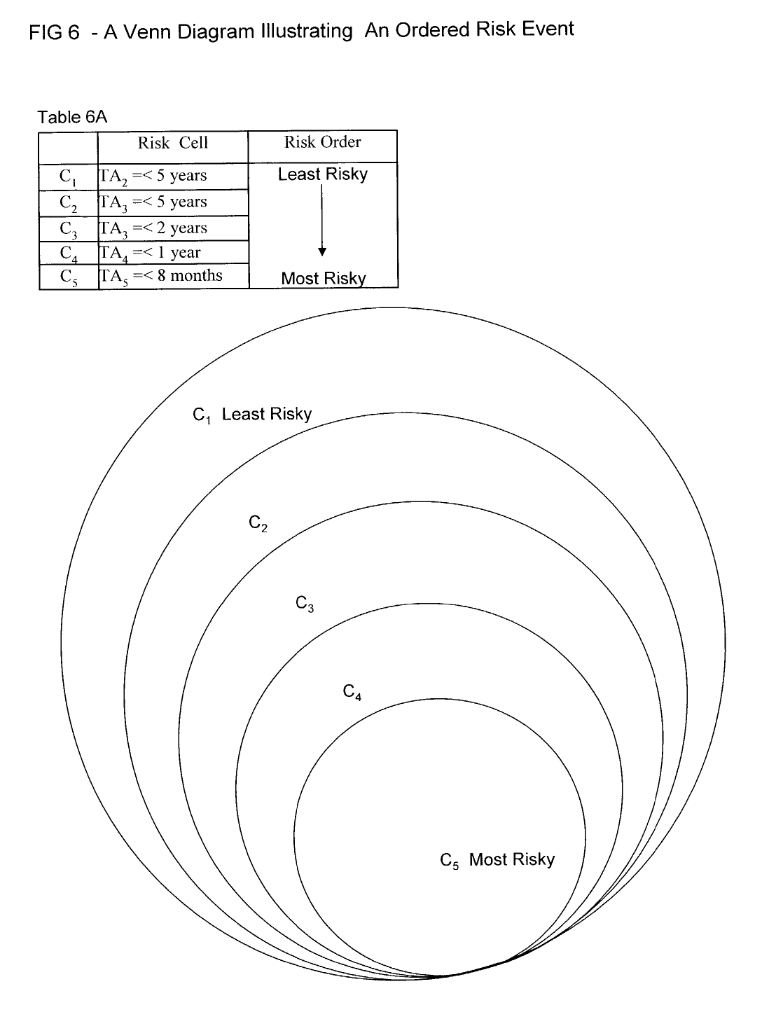

In FIG. 6, an example of an ordered risk event is illustrated using a Venn diagram. The risk event is a combination of five risk cells. The risk cells are ranked in order in Table 6A, according to the severity and urgency levels of the performance statuses. Since risk cell C₁ represents the lowest level of severity and urgency, it contains the most customers and is the largest circle. Risk cell C₂ contains customers with a more severe performance status. If a customer is in risk cell C₂, then the customer must also be a member of the previous risk cell, C₁, because more severe and more urgent performance statuses can occur only after less severe and less urgent performance statuses have occurred. Thus risk cell C₂ is contained within risk cell C₁. Similarly, risk cell C₃ is contained in risk cell C₂ and the risk cell C₄ is contained in risk cell C₃. The most severe and the most urgent risk cell, C₅, is contained in risk cell C₄. As the Venn diagram illustrates, the performance events in an ordered risk event are finely segmented according severity and urgency, where each subsequent risk cell containing more severe credit performances.

Returning to FIG. 5, the conditional risk is analyzed by developing a set of conditional models, represented by block 57 to forecast the risk of more severe performance statuses. A performance model developed for each ordered risk cell in the ordered risk event to forecast the likelihood of a customer will also be in the next risk cell if the customer is in this particular risk cell. This probability is the likelihood of credit performance worsening from one risk cell to the next risk cell.

The conditional performance models are used to create dynamic score cards, represented by block 58. The dynamic score cards assess credit risk by classifying customers into different segments according to the conditional models. For each segment of customers, a different score card is used to score credit risk. Thus depending on the risk level of customers, different score cards are used. The resultant score is the Dynamic Event Score for the risk event, represented by block 59.

The unordered risk events are scored as described previously. Block 54 represents the scores for the unordered risk events in block 51. The scores for unordered risk events from block 54 and the scores for ordered risk events from block 59 are combined and this combination is the RESCS Score represented by block 510.

Performance Modeling for Ordered Risk Events

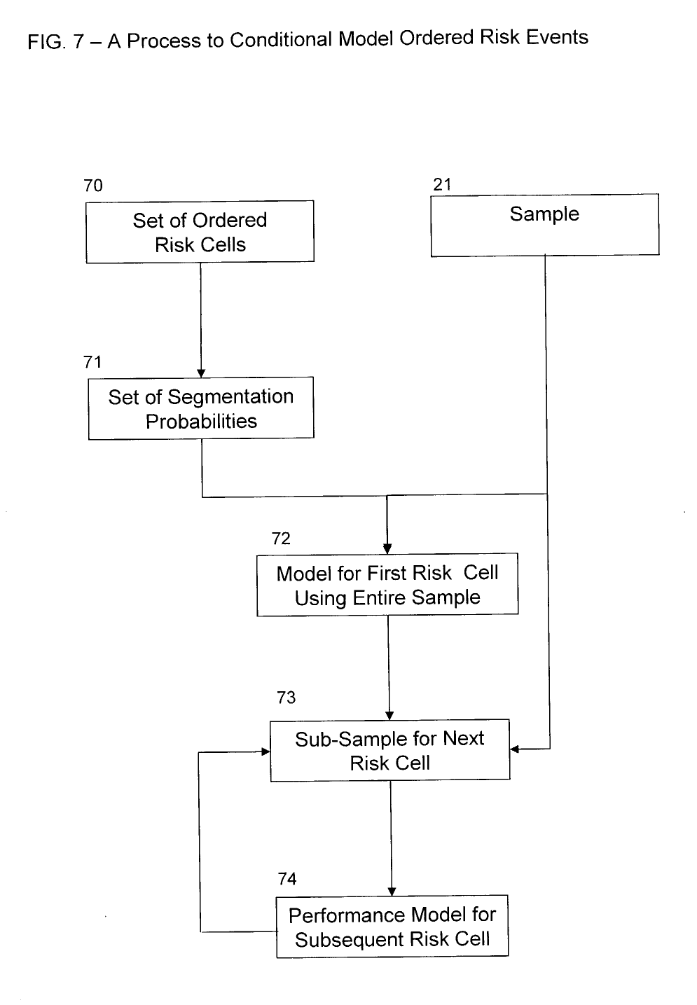

With reference to FIG. 7, a process to create conditional models using dynamic samples is described in further detail. Since the conditional model forecasts conditional risk, the conditional performance models are developed using dynamic samples. Because each conditional model measures the likelihood of more severe performance status given a less severe performance status, the conditional model for a risk cell is developed using a sub-samples containing customers with high probability of being in the previous risk cell. The set of ordered risk cells is represented by block 70. A segmentation probability is selected for each risk cell. The set of segmentation probabilities for the risk cells are represented by block 71. The segmentation probability is the criteria used to select sub-samples for developing conditional models. The model for each of the risk cells is developed using the sub-sample of customers with probability of having performance in the pervious risk cell greater than the predetermined segmentation probability. The sample is represented by block 21, as in FIG. 1.

Performance model 72 is the model for the first risk cell. This model is developed using the entire sample 21. The additional of conditional performance models are created sequentially following the order of the risk cells from the least risky cell to the most risky cell. For each subsequent risk cell, the performance model is developed using a sub-sample of 21. The sub sample is selected by using the performance model for the previous risk cell to forecast the probability of each customer in sample 21 also being a member of the previous risk cell.

Using the segmentation probability for the risk cell from block 71, sample 21 is divided into two sub-samples. The first sub-sample consists of customers with probability of falling into the risk cell lower than the preset segmentation probability. The second sub-sample consists of customers with probability of falling into the risk cell higher than the preset segmentation probability. The second sub-sample is used to develop a performance model for the next risk cell and is represented as block 73. In block 74 represents the performance model for the next risk cell developed using sub-sample 73. Performance model 74 is then used to evaluate sample 21 to select the sub-sample used to model the next risk cell.

The conditional modeling process may be better appreciated by considering an example. Assume that an ordered risk event is ordered using a sequence of five ordered risk cells, C₁<C₂<C₃<C₄<C₅ as illustrated in FIG. 6. The first model, M₁, is developed using the entire sample to forecast the probability of credit performance will be in the first risk cell, C₁.

The performance model for the first risk event is used to divide the customers into two sub-samples, G₁₁ and G₁₂. Performance model M₁ is used to forecast the future credit performance of each customer in the sample. The customers with probability of being in risk cell C₁, less than the segmentation probability for the risk cell are classified in sub-group G₁₁. The remaining customers in the sample have a probability of being in the risk cell C₁ greater than the segmentation probability and are classified in sub-group G₁₂.

The second performance model, M₂, is developed using the sub-sample G₁₂, to forecast the probability of a customer performance falling into the second risk cell C₂. Since customers in the sub-group, G₁₂, have a high probability of being in risk cell C₁ this model forecasts the conditional performance. This model measures the likelihood of customers whose performances are to be in C₁, will also be in risk cell C₂, rolling over to the more severe and/or more urgent cells.

Consequently, model M₂ is used to divide the customers in the sub-sample G₁₂ into two new groups: sub-sample G₂₁, the group of customers with probability falling in C₂ lower than the segmentation probability, and sub-sample G₂₂, the group of customers with probability falling in C₂ higher than the segmentation probability.

The third performance model, M₃, is developed using the sub-sample G₂₂, to forecast the probability of a customer performance falling into the third risk cell C₃. Since customers in the sub-sample, G₂₂, have a high probability of being in risk cell C₂, this model forecasts the conditional performance. This model measures the likelihood of customers whose performances are to be in C₂, will also be in risk cell C₃, rolling over to a more severe and/or more urgent cells. Since risk cell C₂ is subsequent to C₁, C₂ is contained in C₁. This process is repeated for risk cells, C₄, and C₅, whereby each performance model is developed using a sub-sample selected using the previous performance model.

The conditional models forecast the probability of a customer being in a risk cell given that the customer has a high probability of being in the preceding risk cell. Dynamic sub-sampling allows the conditional modeling process to focus on customers with high probability of being in each risk cell. Consequently, the performance models are more accurate because only customers who have a high probability of being in the risk cell are used to develop the model.

Performance Forecasting Using Conditional Models

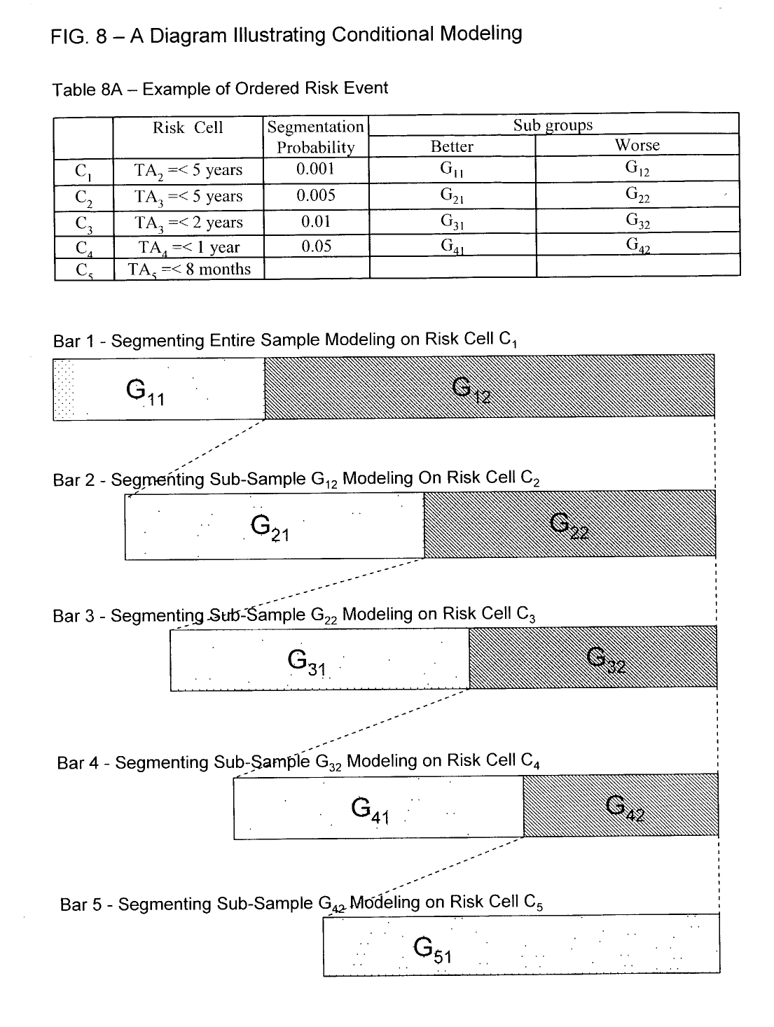

With reference to, FIG. 8, a diagram, a process to forecast performance using conditional models is described in detail.

Table 8A in FIG. 8, shows an example of an ordered risk event with five risk cells, C₁, C₂, C₃, C₄ and C₅. For each risk cell, the system defines a segmentation probability.

For the ordered risk event the conditional performance modeling process builds five models of which four are based on the outcome from the previous model. The five models predict future performance and create five segments of customers. The segments correspond to the risk cells in the risk event and are ordered accordingly, ranking the customers from the most favorable to the least favorable.

The system uses the first model to forecast the probability of customers falling into the first risk cell. The result from the first model is illustrated as Bar 8-1. If a customer has a satisfactory probability (i.e. below the segmentation probability) of falling into the first risk cell, the customer is placed in the first segment, G₁₁. Other customers are placed into the segment G₁₂.

The system uses the second model to predict the probability of customers in the segment G₁₂ falling into the second, more severe, risk cell. The result from the second model is illustrated as Bar 8-2. If a customer has a satisfactory probability (i.e. below than the second segmentation probability) falling into the second risk cell, the customer is placed in the second segment, G₂₁. Other customers are placed into the segment G₂₂

The system uses the third model to predict the probability of customers in the segment G₂₂ falling into the third risk cell. The result from the third model is illustrated as Bar 8-3. If a customer has a satisfactory probability (i.e. below than the third segmentation probability) falling into the third risk cell, the customer is placed in the third segment, G₃₁. Other customers are placed into the segment G₃₂

The system uses the fourth model to predict the probability of customers in the segment G₃₂ falling into the fourth, more severe risk cell. The result from the fourth model is illustrated as Bar 8-4. If a customer has a satisfactory probability (i.e. below than the fourth segmentation probability) falling into the fourth risk cell, the customer is placed in the fourth segment, G₄₁. Other customers are placed into the segment G₄₂

The system uses the fifth model to predict the probability of customers in the segment G₄₂ falling into the fifth severe risk cell. The result from the fifth model is illustrated as Bar 8-5. The customers are placed in the fifth segment, G₅₁.

The credit quality of each segment is controlled by the severity and urgency of risk cells and the corresponding pre-set segmentation probability. By segmenting the customer using the conditional models, the system forecasts credit risk meticulously and fairly.

Dynamic Score Cards

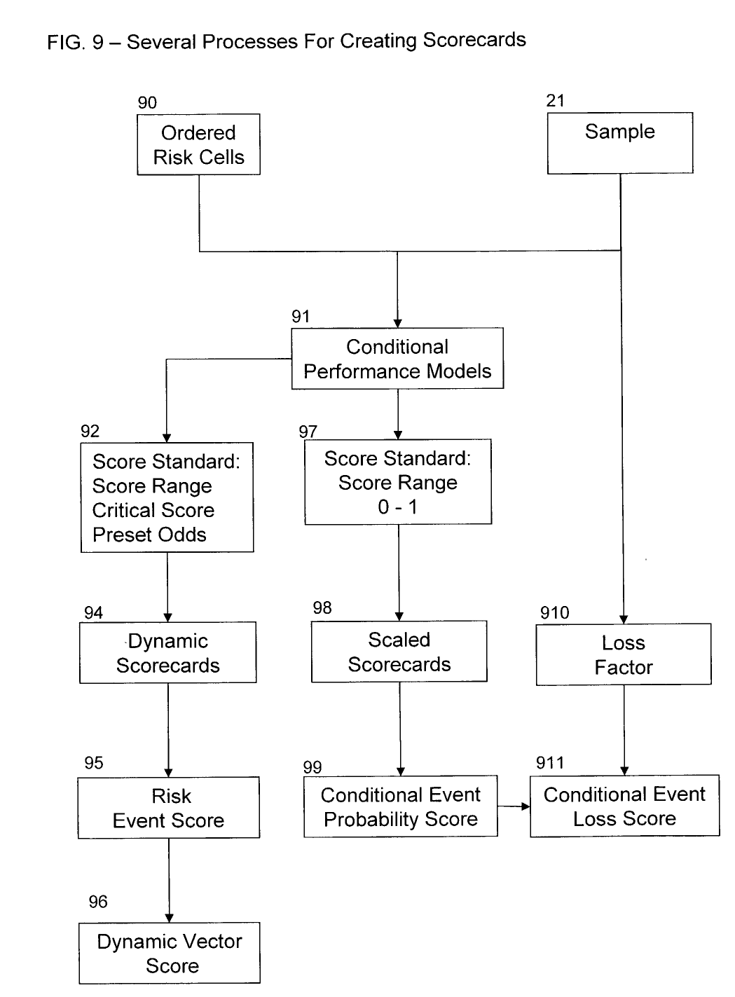

With reference to FIG. 9, a block diagram, several embodiments of the process to create score cards are described in detail.

As described previously, a set of conditional models, represented by block 91, are developed for ordered risk event 90 using sample 21, where a performance model is developed for each ordered risk cell.

The results from the conditional models are rescaled according to score standard 92. The score standard specifies a score range Rₖ, a critical score S_{K} and a preset odd Oₖ, for the k-th score card. A lower score indicates a higher level of risk. For the first score card, the score range is arbitrary, for example, from 0 to 1000. For each subsequent score card, the score range is from the minimum score to the critical score of the previous card. Score standard 92 is used to develop dynamic score cards, represented by block 94. A score card is developed for each of the ordered risk cells. The point values of customer attributes on each score card are scaled according to the score standard. For each score card, score standard specifies a score range, a predetermined critical score and corresponding preset odds. The point values of the attributes are scaled according to score range. The point values are also scaled so that the critical score implies the likelihood of being in the risk cell is equal to the preset odds. Thus the critical score divides customers into two groups, one group with high risk of being in the risk cell and the other group with low probability of being in the risk cell. The rescale score cards are then used to score credit risk. The following table illustrates a set of dynamic score cards and score standards.

| | | | | |
|---|---|---|---|---|
| Card | | Score | Critical | |
| # | Risk Cell | Range | Score | Preset Odds |

| | | | | |
|---|---|---|---|---|
| C₁ | {TA₂ =< 5 years} | 0-1000 | 800 | Pr{TA₂ =< 5 years} = |
| | | | | 0.001 |
| C₂ | {TA₃ =< 5 years} | 0-800 | 600 | Pr{TA₃ =< 4 years} = |
| | | | | 0.005 |
| C₃ | {TA₃ =< 2 years} | 0-600 | 400 | Pr{TA₃ =< 2 years} = |
| | | | | 0.01 |
| C₄ | {TA₄ =< 1 year} | 0-400 | 200 | Pr{TA₄ =< 1 year} = |
| | | | | 0.05 |
| C₅ | {TA₅ =< 8 months} | 0-200 | 100 | Pr{TA₅ =< 8 months} |

Dynamic Credit Scoring

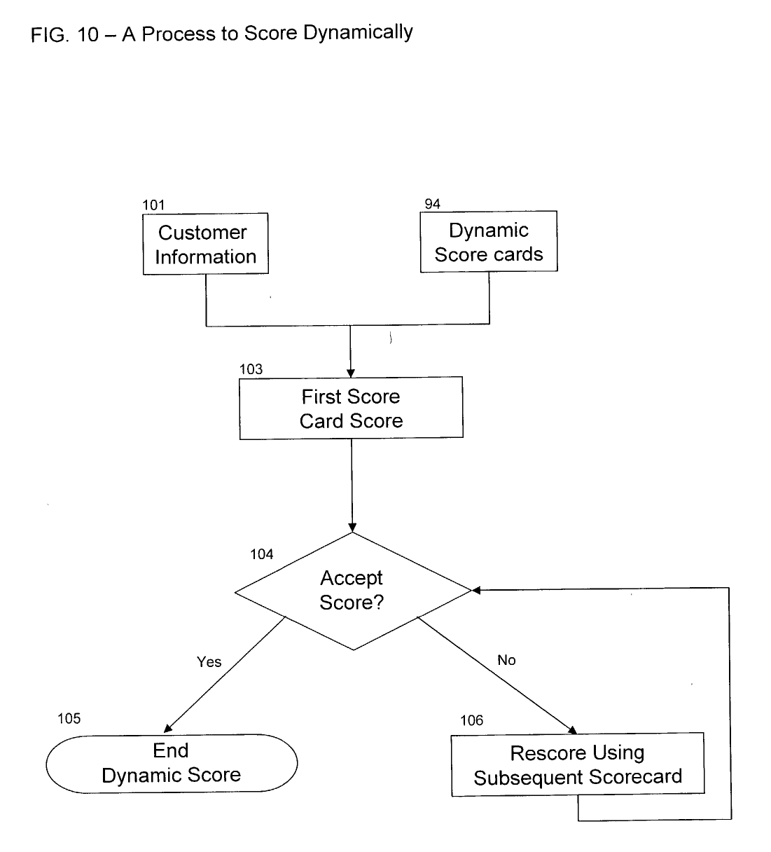

Based on each customer's risk profile, one of score cards from block 94 is selected to score the customer. The customer's score is presented by block 95. With reference to FIG. 10, the process and system to score credit risk using dynamic score cards is described in detail.

Customer attributes 101 are scored using score cards from dynamic score card system 94. Block 103 identifies the step in which customer attributes are scored using a score card. The customer is first scored using the first score card. The score from the first score card is represented by clock 103. The process proceeds to block 104, the step to decide whether to rescore using the next score card or to accept score 103 as the customer's dynamic risk event score. The score is compared with the score standard for the score card. If score 103 is greater or equal to the critical score for the score card or it is the result of the last score card, then the process ends. Block 105 represents the end the process and the customer's dynamic risk event score. If the score 103 is less than the critical score for the score card, then the process proceeds to block 105. Block 105 represents the step in which the customer is scored using the next score card. The process then returns to step 103 to decide whether to accept this new score as the customer's dynamic risk events score.

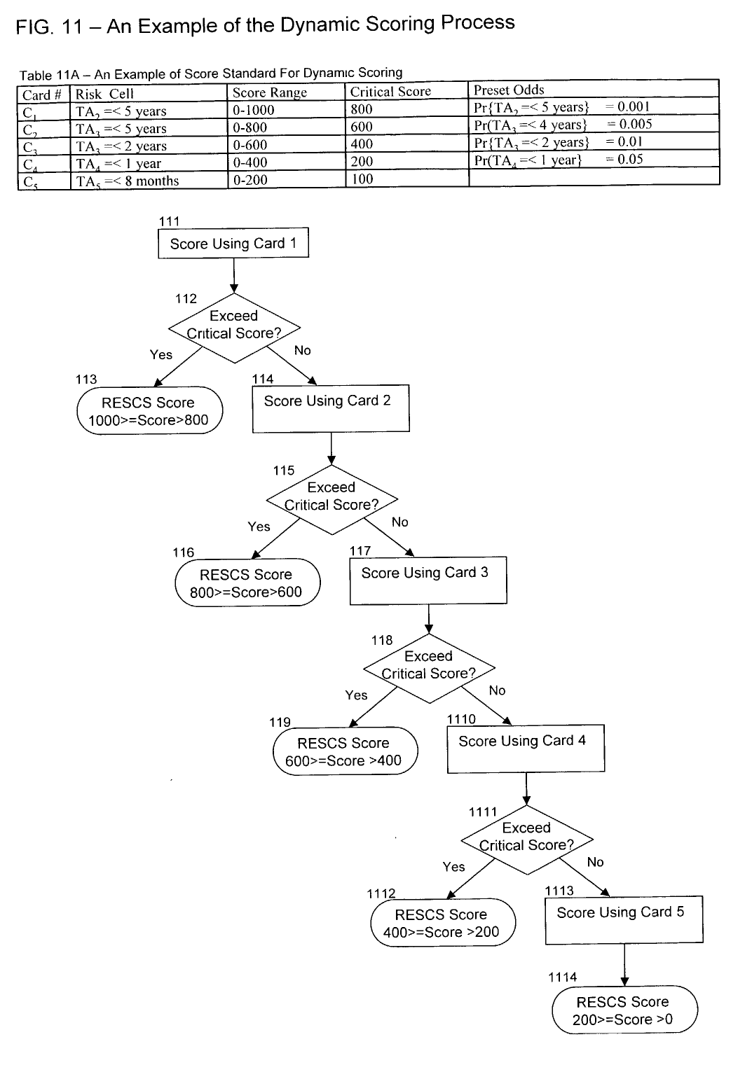

With reference to FIG. 11, an example of the dynamic scoring process of FIG. 10 is described in detail. Table 11A, shows an example of a score standard for an ordered risk event with five risk cells. The score standard comprises of a score range, a critical score and a preset odds. Using the score standard, a score card for each risk cell is developed.

In block 111, the system scores the customer using the first score card. In block 112, if the credit score from the first card is greater than 800, then the system proceeds to block 113. Otherwise, system proceeds to block 114. In block 113, the process ends and system uses the score from the first score card as the customer's Dynamic RESCS Score.

In block 114, the system rescores the customer using the second score card. In block 115, if the second score is greater than 600, then the system proceeds to block 116. Otherwise the system proceeds to block 117. In block 116, the process ends and system uses the score from the second score card as the customer's Dynamic RESCS Score.

In block 117, the system rescores the customer using the third score card. In block 118, if the third score is greater than 400, system proceeds to block 119. Otherwise the system proceeds to block 1110. In block 119, the process ends and system uses the score from the third score card as the customer's Dynamic RESCS Score.

In block 1110, the system rescores the customer using the fourth score card. In block 1111, if the fourth score is greater than 200, then the system proceeds to block 1112. Otherwise the system proceeds to block 1113. In block 1112, the process ends and system uses the score from the fourth score card as the customer's Dynamic RESCS Score.

In block 1113, the system rescores the customer using the fifth score card. In block 1114, the process ends and the system uses the score from the fifth score card as the customer's Dynamic RESCS credit score.

A credit score produced by this approach could represent to different levels of credit risk. For example, consider two customers each had a 20% chance having bad performance within two years, but the first customer also had a 10% chance of defaulting within the first year, whereas the second customer only had 2% chance of defaulting within the first year. Using the prior art credit scoring system, both customers would have the same credit score. However, the first customer had a higher credit risk than the second customer since the first customer was five times more likely to default within the first year.

This embodiment significantly improves the prior arts method of combining multiple independently developed scoring systems by focusing on the evolving process of bad performance.

Dynamic Vector Score

With reference to FIG. 9, additional embodiments of scoring ordered risk events are described in detail.

In one embodiment, the final score is the vector of the scores from each of the dynamic score cards. The creditors use each of the score cards from block 94 to score customers. The score vector is then:

$$Score Vector = \begin{matrix}\{ & a & Dynamic RESCS Score from block 95 \\ & {x}_{1} & Score from first score card . \\ & {x}_{2} & Score from second score card , \\ & {x}_{3} & Score from third score card , \\ & \cdot & \\ & {x}_{n} & Score from the Nth score card \}\end{matrix}$$

The Dynamic Vector Score is represented by block 96. The Dynamic Vector Score is a significant improvement over the prior arts' method of using multiple independent scoring systems.

Conditional Probability

In another embodiment, the score measures the conditional probability of future performance will be in each of the risk cell instead of the scaled scores. The score standard 97 specifies the score range is from 0 to 1. The conditional performance model coefficients are scaled according to score standard 97 to create score cards 98. The set of scores from each of the score cards from block 98 is the Conditional Event Probability Score. This score measure the conditional probability future performance will in worsen into the next risk cell.

The following table is an example of Conditional Event Probability Score. As the risk level increases, the likelihood of a customer to be in a risk event generally decreases.

| | |
|---|---|
| i. | 10% chance of having {TA₂ =< 5 years}, at least one account |
| | will be 30 days past due in the next 5 years, |
| ii. | 7% chance of having {TA₃ =< 4 years}, at least one account |
| | will be 60 days past due in the next 4 years, |
| iii. | 5% chance of having {TA₃ =< 3 years}, at least one account |
| | will be 60 days past due in the next 3 years, |
| iv. | 1% chance of having {TA₄ =< 1.5 year}, at least one account |
| | will be 90 days past due in the next 1.5 years, |
| v. | 0.4% chance of having {TA₅ =< 8 months}, at least one account will |
| | be in foreclosure, repossession, or written off in the next 8 month. |

Conditional Loss Score

In additional embodiment, the score measures the expected loss from worsening future performance. The system calculates the loss factor or expected loss for each risk cell exclusively using empirical loss data from the sample. The set of loss factors are represented by block 910. The loss factor for each risk cell is multiplied by the Conditional Event Probability Score 99 to obtain the Conditional Event Loss Score, which is represented by block 911.

RESCS Score

This invention scores the credit worthiness of a customer by assessing the likelihood of different levels of bad performance represented by multiple risk events. A credit score is calculated for each risk event to measure the likelihood of each level of bad performances. Thus the RESCS score is a set of scores measuring the likelihood of different performance events as described in the above section. The following table lists examples of RESCS score.

| Risk | | | Score | Credit |
|---|---|---|---|---|
| Event | Ordered | Risk Cells | Format | Score |
| E₁ | No | {TB₁ =< 3 years} or | Event Score | 500 |
| | | {TA₃ = < 2 years} | | |
| E₂ | No | {TA₅ =< 2 years} or | Event Score | 650 |
| | | {TB₂ = < 1 years} | | |
| E₃ | No | {TA₃ =< 3 years} and | Event | 5% |
| | | {TA₄ > 3 years} | Probability | |
| E₄ | No | {TA₃ >= 3 years} and | Event Loss | 1% |
| | | {TA₃ < 4 years} | Factor | |
| E₅ | No | {TA₃ >= 3 years} and | Event Loss | 1.5% |
| | | {TB₃ >= 4 years} | Factor | |
| E₆ | Yes | C₁ = {TA₂ =< 5 years}; | Dynamic | 670 |
| | | C₂ = {TA₃ =< 4 years}; | RESCS Score | |
| | | C₃ = {TA₃ =< 2 years}; | | |
| | | C₄ = {TA₄ =< 1 year}; | | |
| | | C₅ = {TA₅ =< 8 month} | | |

Using this present invention, a creditor can choose to order all, some or none of the defined risk events and can choose from several different score methods. The final score given to a customer can be a combination of the different scores of risk models of this invention.

As described above, this invention offers great flexibility. Creditors may create a scoring system with one ordered risk event. This risk event is classified by multiple risk cells. Furthermore credit performances are divided into multiple risk events. This system measures credit risk using only on dynamic score, or a vector of scores dynamically.

RESCS Applications

Customer Segmentation

The RESCS system uses risk events and risk cells to classify and segment credit performances. The system then develops performance models to forecast future credit performance and classify customers using risk events. Consequently, the customers are divided into segments according to the risk events and the risk cells. Since each segment represents one particular level of bad performance, the greater number of risk events and risk cells are defined, the finer the segmentation of customers will be.

Portfolio Loss Valuation

By determining the RESCS score for each customer in a portfolio, portfolio loss can be estimated accurately. The RESCS score shows the probability of customers having performance in each risk cell. The expected loss factor for each risk cell could be accurately calculated using empirical loss data from sample customers in the risk cell. Additionally, the expected loss factor can be calculated using the severity and urgency characteristics of the risk cell. The expected loss of each customer is the product of the credit at risk, the expected loss factor for each risk cell, and the probability of performance falling into each risk cell. Then the portfolio expected loss forecast is:

PV=V₁+V₂+V₃+. . . +Vₙ;

where V₁, V₂, V₃, . . . Vₙ are the expected losses from each account.

Credit Approval and Application Solicitation

To originate a credit product, either through customer applications or a creditor's solicitation, the creditor obtains a RESCS score for each potential customer. The creditor sets a cut-off score for approval of a credit: if a customer's score is above the cut-off score, he/she will be approved or solicited; otherwise he/she will be declined or not solicited. The principle of setting a cut-off score is to reduce the credit risk for the new portfolio. Since RESCS provide very fine segmentation of customers, setting a cut-off score is equivalent to choosing which segments are approved. Combining the valuation process outlined above, the creditor will ensure the credit quality of a portfolio.

Risk Based Pricing System

The creditor can use this present invention to create a risk based pricing system. By approving different segments of potential customers, the creditor is well aware of the different credit risk of customers between segments and within a segment. Using a risk based pricing system, the creditor is able to offer credit to customers at a price that is based on their credit risk. For example, for customers in the most favorable segment, the creditor charges a base price. For customers in second favorable segment, the creditor charges a premium, say, of 5%. The creditor can also charge higher premium for customers in other segments.

A creditor can also set the price directly linked to the RESCS score instead of to the segments.

Prepayment Forecasting

A creditor can use this present invention to forecast the risk of prepayment. The creditor can create a risk event containing risk cells involving prepayment activity, such as {B₃=<T}, where T is a time period of interest to the creditor. By forecasting the probability of a customer will be in this risk event, the creditor forecasts the customers' future prepayment behavior. Additionally, by using this risk cell in the RESCS scoring system, the creditor can incorporate the risk of prepayment into the credit score.

Thus the present invention provides a method and a system to forecast the timing and severity of future credit performance. Additionally, the present invention provides a method and a system to more accurately score credit risk by using the aforementioned system. Furthermore the present invention provides a method and a system to more accurately value portfolios of credit products using the aforementioned credit scoring system.

The above detailed description only represents some preferred embodiments of the present invention. The specifics and examples should not be construed as limitations on the scope of this present invention. As it is readily apparent to persons having ordinary skill in the art, additional variations and modifications can be made while remaining within the spirit and scope of the invention. Additionally, it should be readily understood that the invention may be capable of other and different tasks. Therefore, the foregoing disclosure and drawing figures are for illustrative purposes only, and do not in any way limit the invention, which is defined by the appended claims.

What we claim is:

1. A method to assess credit risk comprising the steps of:
a. selecting a sample of past credit accounts;
b. a means to classify customers into risk events according to the severity and urgency of payment behavior;
c. developing score card for each risk event;
d. scoring customer using said score cards.

2. The process of claim 1 wherein said risk event is a set of risk cells or combinations of risk cells joined using set operators comprising of: and, or, not.

3. The process of claim 2 wherein each of said risk cells is a collection of customers with a specified performance status with a specified urgency.

4. The process of claim 3 wherein said performance status is chosen from a set of account statuses.

5. The process of claim 3 wherein said performance status is chosen from a set of number of missed payments.

6. The process of claim 3 wherein said performance status is chosen from a set of performance statuses that includes either or both of
prepayment status; and
bankruptcy status.

7. The process of claim 3 wherein said urgency is measured by the first occurrence time of said performance status: where the first occurrence time is:
length of observation period until said performance status occur.

8. The process of claim 1 further comprising the step of: classifying the customer in at least one of said risk events using ordered risk cells.

9. The process of claim 8, wherein the step of creating score cards for said risk events, further comprising the step of:
creating a score card for each risk cell in each of ordered risk events;

10. The process of claim 9, wherein creating score cards for risk cells in said ordered risk event, comprising;
developing a performance model for the first risk cell using said sample,
developing a performance model for each of the subsequent risk cells using a subset of said sample,
developing score cards using each model.

11. The process of claim 10 wherein said subset is selected comprising the steps of:
setting a segmentation probability, wherein said segmentation probability is the criteria to select a sub sample,
using the performance model for the preceding risk cell to evaluate the customers in the sample used to create the preceding model,
selecting customers who have probability of being a member of the preceding risk cell exceeding the segmentation probability.

12. The process of claim 11 wherein said creating score cards further comprising the steps of:
creating a score standard for each score card,
resealing each score cards using the score standard.

13. The process of claim 12 wherein said score standard comprising;
a score range,
a critical score,
a preset odd.

14. The process of claim 13 wherein said score standard comprising;
the maximum score for the first score card is the score range,
the maximum score each subsequent score card is the critical score of previous score card.

15 The process of claim 14 wherein said creating a score standard with the additional step of choosing a preset odds value for each score card whereby a customer with the critical score will have the preset odds of being in the risk event.

16. The process of claim 15 wherein the step of scoring, a customer is scored using score cards in order until a score exceeds the critical score for the score card or all the score cards have been used, whereby the score for the risk event is last score.

17. The process of claim 15 wherein the step of scoring comprising
scoring using each score card.
whereby the credit score is a vector wherein the first element is the first score that exceeds the critical score for the score card, or the score from the last score card, the remaining elements are the scores from the remaining score cards.

18. The process of claim 12 wherein the score range of each score card is 0 to 1, whereby the credit score is a vector representing the conditional probability of being each risk cell given that the customer has a high probability of being in the preceding risk cell.

19 The process of claim 18 wherein the step of scoring, further comprising the steps of:
determining the annual loss factor for each risk cell, wherein said annual loss factor is the average annual loss rate of sample customers in the risk cell.
calculating the expected loss from falling each risk cell,
summing the expected loss from each risk cell,
whereby the credit score is the expected loss with respect to the risk event.

20. The process of claim 1 wherein the step of creating score cards comprising the steps of:
classifying sample customers using risk events wherein said customers are classified by their membership in risk events,
developing performance models for each of said risk events, wherein said models use customer attributes to forecast membership in risk events,
developing score cards for each of said risk events,
whereby said performance models forecast credit performance by forecasting membership in each risk event.

21. The process of claim 20 wherein the step of creating score cards, creating score cards for each risk event, whereby each score card is used to assess credit risk with respect to a risk event.

20. The process of claim 21 wherein the step of creating score card for a risk event with the additional step of:
scaling the point values of customer attributes whereby the score ranges from 0 to 1, and,
whereby the score from said score card is the probability of being in said risk event.

23. The process of claim 22 wherein the step of creating score card, comprising the steps of:
determining the annual loss factor for said risk event, wherein said loss factor is the average annual loss rate of sample customers in said risk event,
whereby the score is calculated by multiplying said annual loss factor with score from the score card, and, whereby the score is the expected loss rate with respect to said risk event.
